(19) United States
(12) Patent Application Publication
(10) Pub. No.: US 2012/0237184 A1
(43) Pub. Date: Sep. 20, 2012

(54) Signal Output Apparatus

(75) Inventor: Eiji TAKEUCHI, Hamamatsu-shi (JP)

(73) Assignee: YAMAHA CORPORATION, Hamamatsu-shi (JP)

(21) Appl. No.: 13/418,909

(22) Filed: Mar. 13, 2012

(30) Foreign Application Priority Data
Mar. 14, 2011 (JP) 2011-055692

(51) Int. Cl. H04N 9/80

(52) U.S. Cl. 386/248; 386/E09.011

(57) ABSTRACT

A signal output apparatus includes: a signal acquiring unit acquiring a video signal and a first audio signal; a measurement sound supplying unit supplying a second audio signal; a first outputting unit outputting the acquired video signal and the supplied second audio signal to a reproduction apparatus; a delay acquiring unit acquiring the second audio signal delayed in the reproduction apparatus; a measuring unit comparing the output second audio signal with the acquired second audio signal, to measure an amount of temporal deviation; a delay controlling unit applying a delaying process to the acquired first audio signal with a delay time period corresponding to the deviation amount; and a second outputting unit outputting the first audio signal to which the delaying process is applied, to a sound emitting unit.

### BACKGROUND OF THE INVENTION

The present invention relates to a technique for outputting an audio signal while delaying the signal.

With the spread of display apparatuses such as a thin display apparatus having a large display screen, also home theater systems are in widespread use. In a home theater system, an audio signal is output to external speakers by using an AV (Audio Visual) amplifier or the like, thereby allowing the viewer to enjoy audio at high volume and with high sound quality. In a display apparatus which may be used in a home theater, usually, high definition video can be displayed by using a digital signal.

A reproduction processing time period which is required to elapse between reproduction of a digital video signal and display of a video on a display screen (hereinafter, such a time period is referred to as the video reproduction processing time period) is longer than a reproduction processing time period which is required to elapse between reproduction of an audio signal and sound emission (hereinafter, such a time period is referred to as the audio reproduction processing time period). Therefore, a display apparatus performs a control so that the audio signal which is input together with the video signal is delayed by an internal process to correct a temporal deviation caused by the difference between the video reproduction processing time period and the audio reproduction processing time period, thereby making the contents of the emitted sound temporally coincident with those of the displayed video. Usually, an operation of synchronizing the contents of an emitted sound with those of displayed video is called lip-sync. In the following description, a control of making the contents of the emitted sound temporally coincident with those of the displayed video is referred to as the lip-sync control.

In the case where an AV amplifier is used, the AV amplifier outputs a video signal to a display apparatus, and reproduces an audio signal and then outputs the reproduced audio signal to an external speaker apparatus to emit a sound. In the AV amplifier, at this time, the audio signal must be delayed in order to perform the lip-sync control. The delay time period must be previously set to a value at which the viewer does not have a feeling of strangeness caused by the viewing contents. As a technique for saving the viewer from such a trouble, JP-A-2006-33436 discloses a technique in which a display apparatus previously stores the video reproduction processing time period, and an AV amplifier reads the video reproduction processing time period stored in the display apparatus, and then sets the delay time period of an audio signal.

In the case where the video reproduction processing time period is previously stored in a display apparatus as disclosed in JP-A-2006-33436, an AV amplifier can read the video reproduction processing time period, but not all display apparatuses store the video reproduction processing time period. Even in the case where the video reproduction processing time period is stored, its value may sometimes not be relied upon. Even when an AV amplifier which can read the video reproduction processing time period is used, therefore, the viewer still must set the delay time period while checking the contents of the actually displayed video and those of the emitted sound.

### SUMMARY

It is therefore an object of the invention to provide a signal output apparatus which, even when information of the video reproduction processing time cannot be acquired from a display apparatus, measures the video reproduction processing time in the display apparatus, and which controls the delay time period of an audio signal.

In order to achieve the object, according to the invention, there is provided a signal output apparatus comprising: a signal acquiring unit configured to acquire a video signal and a first audio signal; a measurement sound supplying unit configured to supply a second audio signal for measuring a delay; a first outputting unit configured to output the acquired video signal and the supplied second audio signal to a reproduction apparatus that is configured to reproduce a video signal to be input and that is configured to delay and reproduce an audio signal to be input; a delay acquiring unit configured to acquire the second audio signal which is delayed in the reproduction apparatus; a measuring unit configured to compare the second audio signal which is output from the first outputting unit with the second audio signal which is acquired by the delay acquiring unit, to measure an amount of temporal deviation; a delay controlling unit configured to apply a delaying process to the acquired first audio signal with a delay time period corresponding to the measured amount of temporal deviation; and a second outputting unit configured to output the first audio signal to which the delaying process is applied, to a sound emitting unit.

The reproduction apparatus may include an output terminal through which the second audio signal is output, and the delay acquiring unit may acquire the second audio signal which is delayed in the reproduction apparatus from a signal output through the output terminal.

When the measured amount of temporal deviation is changed to an amount which is equal to or larger than a predetermined change amount, the delay controlling unit may change the delay time period.

The measurement sound supplying unit may produce an audio signal indicative of a measurement sound, and supply the audio signal as the second audio signal.

The measurement sound supplying unit may supply the second audio signal by using the first audio signal which is acquired by the signal acquiring unit.

According to the invention, there is also provided a signal output method comprising: acquiring a video signal and a first audio signal; supplying a second audio signal for measuring a delay; outputting the acquired video signal and the supplied second audio signal to a reproduction apparatus that is configured to reproduce a video signal to be input and that is configured to delay and reproduce an audio signal to be input; acquiring the second audio signal which is delayed in the reproduction apparatus; comparing the output second audio signal with the acquired second audio signal, to measure an amount of temporal deviation; applying a delaying process to the acquired first audio signal with a delay time period corresponding to the measured amount of temporal deviation; and outputting the first audio signal to which the delaying process is applied, to a sound emitting unit.

### BRIEF DESCRIPTION OF THE DRAWINGS

FIG. 1 is a block diagram illustrating the configuration of an AV system in an embodiment of the invention.

FIG. 2 is a block diagram illustrating the configuration a television receiver in the embodiment of the invention.

FIG. 3 is a block diagram illustrating the configuration of an AV amplifier in the embodiment of the invention.

FIG. 4 is a flowchart illustrating the delay control in a delay controlling section in the embodiment of the invention.

FIG. 5 is a block diagram illustrating the configuration of an AV amplifier in Modification 1 of the invention.

FIG. 6 is a block diagram illustrating the configuration of an AV system in Modification 2 of the invention.

### DETAILED DESCRIPTION OF EMBODIMENTS

### Embodiment

(Configuration of AV System 1)

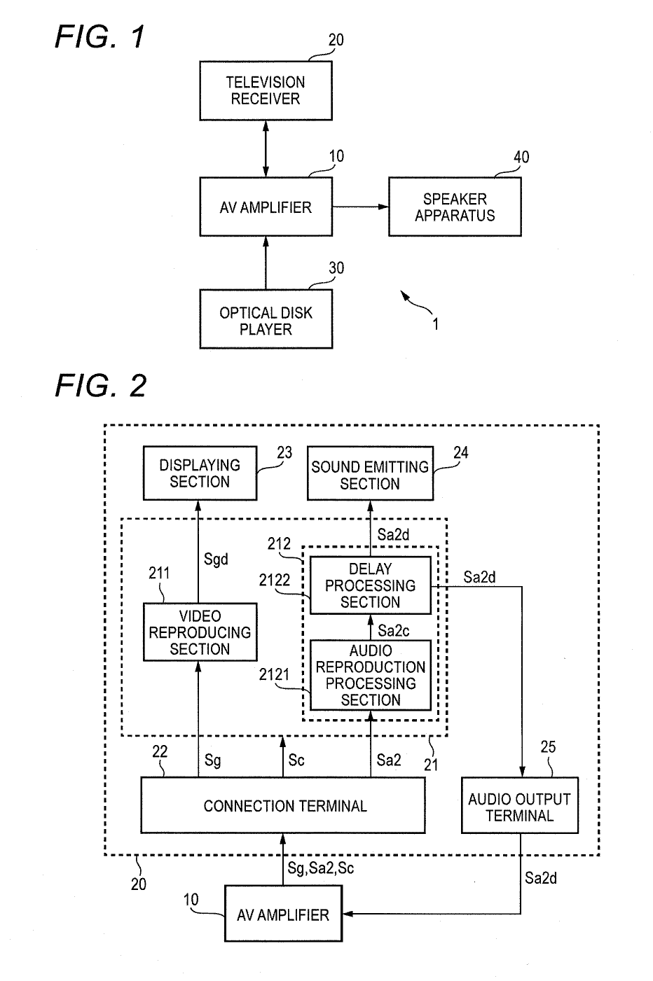

FIG. 1 is a block diagram illustrating the configuration of an AV system 1 in an embodiment of the invention. The AV system 1 has an AV amplifier 10, a television receiver 20, an optical disk player 30, and a speaker apparatus 40. The AV amplifier 10 is connected to the television receiver 20, the optical disk player 30, and the speaker apparatus 40.

The optical disk player 30 reads content data such as a movie recorded on an optical disk such as a DVD (Digital Versatile Disk), and outputs the data to the AV amplifier 10. The content data include a video signal indicating video contents, and an audio signal indicating audio (sound) contents. In this example, the content data further include genre information indicating the genre of the contents and the like.

The AV amplifier 10 outputs the video signal and genre information which are acquired from the optical disk player 30, to the television receiver 20, and outputs the audio signal which is acquired from the optical disk player 30, to the speaker apparatus 40.

The television receiver 20 is a display apparatus having components which are disposed in a usual television receiver, such as a display screen which displays video corresponding to an input video signal, a speaker which outputs a sound corresponding to an input audio signal, and a tuner which acquires a broadcast signal, and which converts the signal to a video signal and an audio signal. The television receiver 20 may be a monitor which does not have a tuner.

The configuration of the AV system 1 has been described. Next, the configurations of the television receiver 20 and the AV amplifier 10 will be sequentially described in detail.

(Configuration of Television Receiver 20)

FIG. 2 is a block diagram illustrating the configuration of the television receiver 20 in the embodiment of the invention. The television receiver 20 has a DSP (Digital Signal Processor) 21, a connection terminal 22, a displaying section 23, a sound emitting section 24, and an audio output terminal 25.

The connection terminal 22 is a terminal to which a cable functioning as a path of transmitting and receiving information to and from an external apparatus is to be connected, and configured in accordance with, for example, the HDMI (registered trademark) standards. In the example, the connection terminal 22 is connected to a cable which is connected to the AV amplifier 10, and receives data transmitted from the AV amplifier 10. The data transmitted from the AV amplifier 10 include a video signal Sg, an audio signal Sa2, and genre information Sc. The connection terminal 22 outputs the data transmitted from the AV amplifier 10, to the DSP 21.

The DSP 21 is a reproduction apparatus which has a video reproducing section 211 and an audio reproducing section 212, and outputs signals which are obtained by reproducing the video signal Sg and the audio signal Sa2 that are supplied from the connection terminal 22 (such reproduced signals are referred to as the reproduced video signal Sgd and the reproduced audio signal Sa2d, respectively). The configuration of the DSP 21 will be described later.

The displaying section 23 has a display screen, and displays video corresponding to the reproduced video signal Sgd supplied from the DSP 21, on the display screen. The sound emitting section 24 has a speaker, and outputs a sound corresponding to the reproduced audio signal Sa2d supplied from the DSP 21. The audio output terminal 25 is a terminal to which a cable functioning as a path of outputting the reproduced audio signal Sa2d supplied from the DSP 21 to an external apparatus is to be connected. In the example, the audio output terminal is connected to a cable which is connected to the AV amplifier 10, and outputs the reproduced audio signal Sa2d to the AV amplifier 10.

Upon acquiring the genre information Sc, the DSP 21 sets a reproduction mode in accordance with the contents of the genre information Sc. The reproduction mode is configured by a plurality of modes such as a movie mode and a game mode, and the contents (such as the image quality, the sound quality, and the effect process) of the reproduction processes in the video reproducing section 211 and the audio reproducing section 212 are defined for each mode. Alternatively, the reproduction mode may not be used. In the alternative, it is not necessary to acquire the genre information Sc. In the case of a configuration where the DSP 21 does not acquire the genre information Sc, such as the case where the optical disk player 30 does not transmit the genre information Sc, a reproduction mode which is set by the viewer or the like, that which is a default setting, or the like may be used.

The video reproducing section 211 reproduces the input video signal Sg, and outputs the reproduced signal as the reproduced video signal Sgd to the displaying section 23, thereby causing video to be displayed on the display screen.

In the video reproducing section 211, the reproduction processing time period which is a time period from the input of the video signal Sg to the output of the reproduced video signal Sgd is changed in accordance with the contents of the reproduction mode which is set as described above, and the format of the video signal Sg. The format of the video signal Sg means, for example, conditions such as the number of scanning lines, the scanning method (interlace or progressive), the frame rate, and 2D or 3D. The video reproducing section 211 determines the format of the video signal Sg from the video signal Sg, or acquires an identification signal indicative of the format of the video signal Sg to determine the format.

The audio reproducing section 212 reproduces the input audio signal Sat while delaying the signal, and outputs the reproduced signal as the reproduced audio signal Sa2d. In the example, in the case where a cable is connected to the audio output terminal 25, the audio reproducing section 212 outputs the reproduced audio signal Sa2d to the audio output terminal 25, and the reproduced audio signal Sa2d is supplied to the external apparatus connected to the cable. By contrast, in the case where a cable is not connected to the audio output terminal 25, the audio reproducing section 212 outputs the reproduced audio signal Sa2d to the sound emitting section 24, thereby causing the sound emitting section 24 to emit a sound.

In the example, the cable connected to the AV amplifier 10 is connected to the audio output terminal 25, and therefore the audio reproducing section 212 outputs the reproduced audio signal Sa2d to the audio output terminal 25, and does not the signal to the sound emitting section 24.

In the example, the audio reproducing section 212 has: an audio reproduction processing section 2121 which reproduces the audio signal Sa2, and which outputs the reproduced signal as a reproduced audio signal Sa2c; and a delay processing section 2122 which delays the reproduced audio signal Sa2c, and which outputs the delayed signal as the reproduced audio signal Sa2d. In the audio reproduction processing section 2121, the audio reproduction processing time period from the input of the audio signal Sa2 to the output of the reproduced audio signal Sa2c is shorter than the above-described video reproduction processing time period. The delay time period in the process of delaying the reproduced audio signal Sa2c in the delay processing section 2122 is set as a difference time period between the video reproduction processing time period and the audio reproduction processing time period so that the lip-sync control is realized. When the video reproduction processing time period is changed, therefore, also the set delay time period is changed. In the audio reproducing section 212, the delaying process is applied to the reproduced audio signal, and alternatively the audio signal may be reproduced after the audio signal may be first subjected to the delaying process, and then reproduced.

The configuration of the television receiver 20 has been described.

(Configuration of AV Amplifier 10)

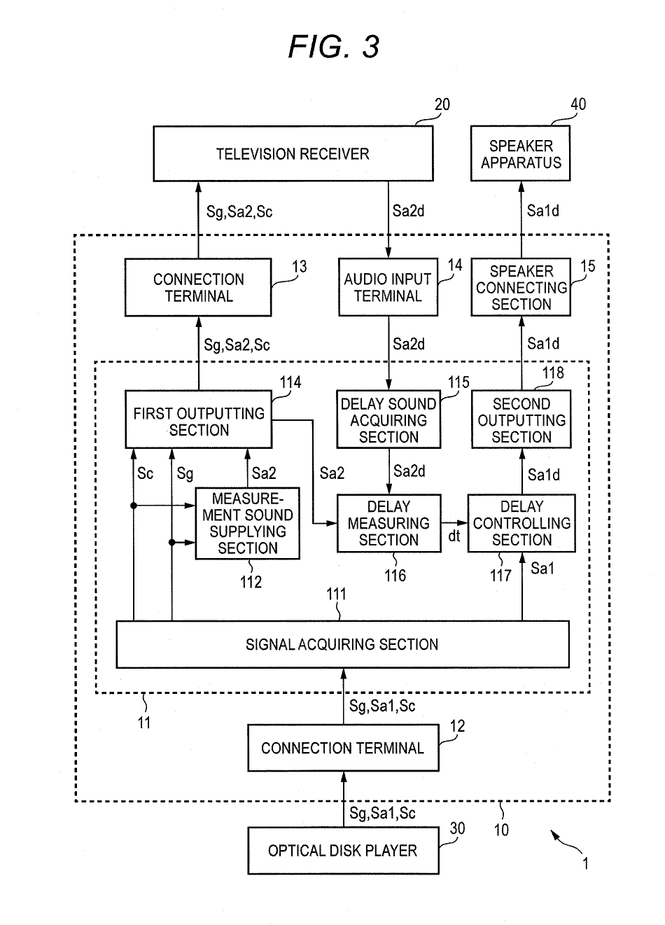

FIG. 3 is a block diagram illustrating the configuration of the AV amplifier 10 in the embodiment of the invention. The AV amplifier 10 has a DSP 11, connection terminals 12, 13, an audio input terminal 14, and a speaker connecting section 15.

Similarly with the connection terminal 22, the connection terminals 12, 13 are terminals to which a cable functioning as a path of transmitting and receiving data to and from an external apparatus is to be connected, and configured in accordance with, for example, the HDMI standards. In the example, the connection terminal 12 is connected to a cable which is connected to the optical disk player 30, and receives data transmitted from the optical disk player 30. The data transmitted from the optical disk player 30 include a video signal Sg, an audio signal Sa1, and genre information Sc. The connection terminal 12 outputs the data transmitted from the optical disk player 30, to the DSP 11. The connection terminal 13 is connected to a cable which is connected to the television receiver 20 (the connection terminal 22), and transmits data to the television receiver 20. As described above, the data transmitted to the television receiver 20 include the video signal Sg, the audio signal Sa2, and the genre information Sc.

The audio input terminal 14 is a terminal to which a cable functioning as a path of receiving an audio signal from an external apparatus is to be connected. In the example, a cable connected to the television receiver 20 (the audio output terminal 25) is connected to the terminal, and the reproduced audio signal Sa2d is input from the television receiver 20. The audio input terminal 14 supplies the input reproduced audio signal Sa2d to the DSP 11.

The speaker connecting section 15 has a connection terminal to which an external speaker (in the example, the speaker apparatus 40) is connected, and an amplifier which amplifies an audio signal. The speaker connecting section 15 receives an audio signal (a reproduced audio signal Said which will be described later) from the DSP 11. The speaker connecting section 15 amplifies the input reproduced audio signal Said by means of the amplifier, and outputs the amplified signal to the speaker apparatus 40 connected to the speaker connecting section 15, thereby causing the speaker apparatus 40 to emit a sound. In the case where an amplifier is disposed in the speaker apparatus 40, the amplifier may not be disposed in the speaker connecting section 15.

The DSP 11 is a signal output apparatus having a signal acquiring section 111, a measurement sound supplying section 112, a first outputting section 114, a delay sound acquiring section 115, a delay measuring section 116, a delay controlling section 117, and a second outputting section 118.

The signal acquiring section 111 acquires the video signal Sg, the audio signal Sa1, and the genre information Sc from the connection terminal 12. The signal acquiring section 111 outputs the acquired video signal Sg and genre information Sc to the first outputting section 114, and outputs the acquired audio signal Sa1 to the delay controlling section 117.

The measurement sound supplying section 112 produces a delay measurement audio signal Sa2 for measuring the delay time period of an audio signal in the television receiver 20, and supplies the signal to the first outputting section 114. In the example, the measurement sound supplying section 112 monitors the video signal Sg or genre information Sc supplied from the signal acquiring section 111, and, in the case where the format of the video signal Sg is changed, or where the contents of the genre information Sc is changed, produces the audio signal Sa2 for a predetermined time period. For example, the audio signal Sa2 may be a signal indicative of a time-varying sound such as: an impulse sound which is output at constant intervals; a white noise which is intermittently output; or a sound in which the volume level is changed at a constant period, or a sinusoidal signal. Namely, the audio signal Sa2 may be any kind of signal, as far as it indicates a measurement sound in which any parameter shows temporal variation, such as temporal variation of the signal level, or that of the frequency distribution.

Even when any kind of audio signal is supplied to the television receiver 20, a sound is not emitted from the sound emitting section 24 of the television receiver 20 because, in the example, the cable is connected to the audio output terminal 25 as described above. Alternatively, the audio signal Sa2 may be always produced irrespective of a format change of the video signal Sg or the like.

The first outputting section 114 acquires the video signal Sg and the genre information Sc from the signal acquiring section 111, and outputs them to the connection terminal 13. The first outputting section 114 acquires the audio signal Sa2 from the measurement sound supplying section 112, and outputs the signal to the terminal 13 and the delay measuring section 116. Therefore, the video signal Sg, the audio signal Sa2, and the genre information Sc are supplied to the television receiver 20 which is connected to the terminal through the cable.

The delay sound acquiring section 115 acquires the reproduced audio signal Sa2d from the audio input terminal 14, and outputs the signal to the delay measuring section 116. As described above, the reproduced audio signal Sa2d corresponds to the audio signal Sa2 which is delayed in the audio reproducing section 212 of the television receiver 20.

The delay measuring section 116 compares the audio signal Sa2 supplied from the first outputting section 114 with the reproduced audio signal Sa2d supplied from the delay sound acquiring section 115, and measures the amount of temporal deviation. In the case where the audio signal Sa2 indicates an impulse sound, for example, the delay measuring section 116 measures the amount of temporal deviation of the impulse signal. The deviation amount corresponds to the time period from the output of the audio signal Sa2 from the first outputting section 114 to the input of the reproduced audio signal Sa2d to the delay measuring section 116. Hereinafter, the deviation amount is referred to as the measurement time period dt. The total audio delay time period (the audio reproduction processing time period+the delay time period which is set in the delay processing section 2122) in the television receiver 20 is controlled so as to be equal to the video reproduction processing time period. Therefore, the measurement time period dt is a time period approximately corresponding to the video reproduction processing time period. The delay measuring section 116 outputs the measurement time period dt to the delay controlling section 117.

The delay controlling section 117 applies a delaying process with the set delay time period Td to the audio signal Sa1 which is input from the signal acquiring section 111, then reproduces the signal to produce the reproduced audio signal Sa1d, and outputs the reproduced audio signal to the second outputting section 118. In the reproduction of the reproduced audio signal Sa1d, the delay controlling section 117 may perform a signal process such as acoustic effects or the like. In this case, the delaying process may be performed while a time period required for the signal process is subtracted from the delay time period Td.

The delay controlling section 117 performs a delay control in which the delay time period Td in the delaying process is set in accordance with the measurement time period dt acquired from the delay measuring section 116. The delay control which is performed in the delay controlling section 117 will be described.

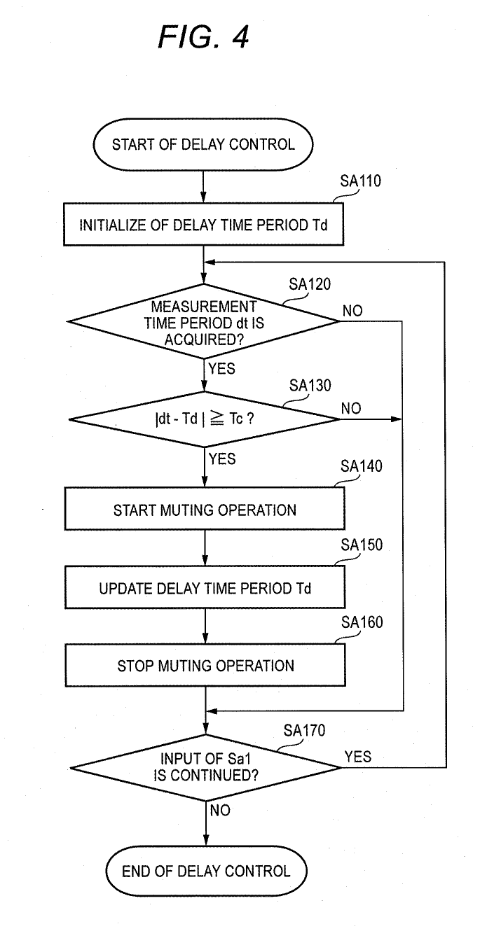

FIG. 4 is a flowchart illustrating the delay control in the delay controlling section 117 in the embodiment of the invention. When the audio signal Sa1 is input, the delay controlling section 117 starts the delay control. First, the delay controlling section 117 performs initialization of the delay time period Td (step SA110). In the example, the initialization means a process in which, in the case where the delay time period Td is not set such as the timing immediately after the start of the power supply to the DSP 11, a predetermined time period is set as the delay time period Td, and, in the case where the delay time period Td has been already set in a past delay control, the set contents are used as the initial value.

The delay controlling section 117 determines whether the measurement time period dt supplied from the delay measuring section 116 is acquired or not (step SA120). If the measurement time period dt is acquired (step SA120: Yes), the delay controlling section 117 determines whether the difference (|dt−Td|) between the delay time period Td and the measurement time period dt is equal to or larger than a predetermined change amount Tc or not (step SA130). If the difference (|dt−Td|) is equal to or larger than the change amount Tc (step SA130: Yes), the delay controlling section 117 temporarily stops the reproduction of the audio signal Sa1, and starts a muting operation (step SA140). When the change amount Tc is large, the deviation between the contents of the video and those of the sound is large, and it cannot be said that the lip-sync control is performed. When the change amount is small, the control is caused to unnecessarily react by a measurement error or the like, and the delay time period Td is changed. Therefore, it is appropriate that the change amount is set to about 10 to 30 msec.

When the muting operation is started, the delay controlling section 117 changes the delay time period Td in accordance with the measurement time period dt, and updates the set contents (step SA150). In the example, the delay controlling section 117 performs the updation by setting the measurement time period dt as a new delay time period Td. Alternatively, the delay controlling section 117 may set a time period which is obtained by correcting and changing the measurement time period dt, as the delay time period Td. The correction amount may be previously set, and, for example, may be set in accordance with the value of the measurement time period dt, or a delay of a signal path other than the measurement path for the measurement time period dt.

When the updation of the delay time period Td is ended, the delay controlling section 117 stops the muting operation (step SA160). If the measurement time period dt is not output from the delay measuring section 116 (step SA120: No), if the difference (|dt−Td|) is not equal to or larger than the change amount Tc (step SA130: No), or after the muting operation is stopped, the delay controlling section 117 determines whether the input of the audio signal Sa1 from the signal acquiring section 111 is continued or not (step SA170). If the input is continued (step SA170: Yes), the delay controlling section again determines whether the measurement time period dt is output or not (step SA120). If the input is not continued (step SA170: No), the delay control is ended. The delay control has been described.

Returning to FIG. 3, the description will be continued. The second outputting section 118 outputs the reproduced audio signal Sa1d which is supplied from the delay controlling section 117, to the speaker connecting section 15. Therefore, the reproduced audio signal Sa1d is input to the speaker apparatus 40 to be emitted as a sound. At this time, in accordance with the measurement time period dt which is measured correspondingly with the audio delay time period that is subjected to the lip-sync control in the audio reproducing section 212 of the television receiver 20, the delay controlling section 117 applies the delaying process to the audio signal Sa1. Therefore, the amount of temporal deviation between the contents of the video displayed on the display screen of the television receiver 20, and those of the sound emitted from the speaker apparatus 40 is reduced, and the lip-sync control is realized. Even when the delay time period in the audio reproducing section 212 is changed, the lip-sync control is realized while following the change.

As described above, the AV amplifier 10 in the embodiment of the invention outputs the delay measurement audio signal Sa2 to the television receiver 20, and acquires the reproduced audio signal Sa2d which is delayed in the television receiver 20, thereby measuring the delay time period in the television receiver 20. Then, the AV amplifier 10 outputs the video signal Sg to the television receiver 20, and outputs the audio signal Sa1 to the speaker apparatus 40 while delaying the audio signal in accordance with the measured delay time period, thereby realizing the lip-sync control between the contents of the video displayed on the display screen of the television receiver 20, and those of the sound emitted from the speaker apparatus 40. Moreover, the AV amplifier 10 measures in real time the delay time period in the television receiver 20, even when the delay time period is changed by a change of the reproduction mode or the like in the television receiver 20, therefore, the lip-sync control can be realized while following the changed delay time period.

(Modifications)

Although, in the above, the embodiment of the invention has been described, the invention can be implemented in various manners as described below.

(Modification 1)

In the above-described embodiment, the measurement sound supplying section 112 supplies the produced signal as the delay measurement audio signal Sa2 to the first outputting section 114. Alternatively, the section may acquire the audio signal Sa1 which is output from the signal acquiring section 111, and supply the signal as the delay measurement audio signal Sa2. In the alternative, the audio signal Sa1 may be used as it is, or may be processed. In the processing process, various processes may be possible such as a process where the signal level is changed, that where the frequency distribution is changed, and that where only some periods of the signal are outputted. In this way, by using the audio signal Sa1, the measurement sound supplying section 112 may supply the delay measurement audio signal Sa2 to the first outputting section 114.

As described in Modification 2 which will be described below, in the case where a microphone 50 picks up a sound from the television receiver 20, it may be contemplated such that the sound and a sound from the speaker apparatus 40 are frequency-separated from each other so that the sound from the speaker apparatus 40 does not cause disturbance (is easily separated), or that a waveform process similar to a digital watermark is applied.

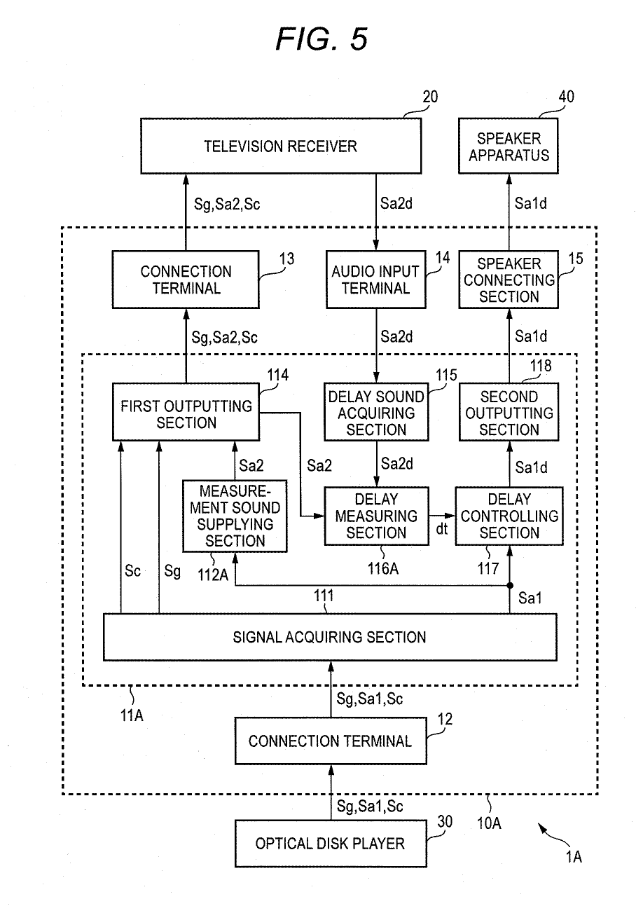

FIG. 5 is a block diagram illustrating the configuration of an AV amplifier 10A in Modification 1 of the invention. The AV amplifier 10A in an AV system 1A shown in FIG. 5 has a DSP 11A of a configuration which is different from that of the DSP 11 of the AV amplifier 10 in the embodiment. In the DSP 11A, the configuration which is different from that of the DSP 11 in the embodiment will be described.

The measurement sound supplying section 112A acquires the audio signal Sa1 supplied from the signal acquiring section 111, and supplies the signal as the delay measurement audio signal Sa2 to the first outputting section 114. In the case where the audio signal Sa1 is configured by a plurality of channels (for example, 5.1 channels) or the like, the measurement sound supplying section 112A may output at least one of the channels as the audio signal Sa2.

Similarly with the delay measuring section 116 in the embodiment, a delay measuring section 116A compares the audio signal Sa2 with the reproduced audio signal Sa2d, and measures the amount of temporal deviation. The audio signal used as the comparison object is an audio signal which is outputted from the optical disk player 30, and is not specially generated audio signal so as to facilitate the measurement of the deviation amount such as that supplied from the measurement sound supplying section 112. Therefore, the delay measuring section 116A can measure the amount of temporal deviation by means of pattern matching which uses a changing pattern of a temporally changing parameter, such as a changing pattern of the sound volume, or that of the frequency spectrum.

In the case where the audio signal Sa1 of the contents is used as the delay measurement audio signal Sa2 as described above, the television receiver 20 may be configured so that the reproduced audio signal Sa2d is supplied from the audio reproducing section 212 also to the sound emitting section 24, and a sound is emitted also from the sound emitting section 24. According to the configuration, both the sound emitting section 24 and the speaker apparatus 40 can perform the sound emission.

(Modification 2)

In the above-described embodiment, the AV amplifier 10 acquires the reproduced audio signal Sa2d supplied from the audio reproducing section 212 of the television receiver 20, through the cable from the audio output terminal 25 of the television receiver 20. Alternatively, the acquisition may be performed in another manner. For example, an audio signal which is obtained by emitting a sound from the sound emitting section 24 of the television receiver 20, and picking up the sound by the microphone 50 may be acquired as the reproduced audio signal Sa2d.

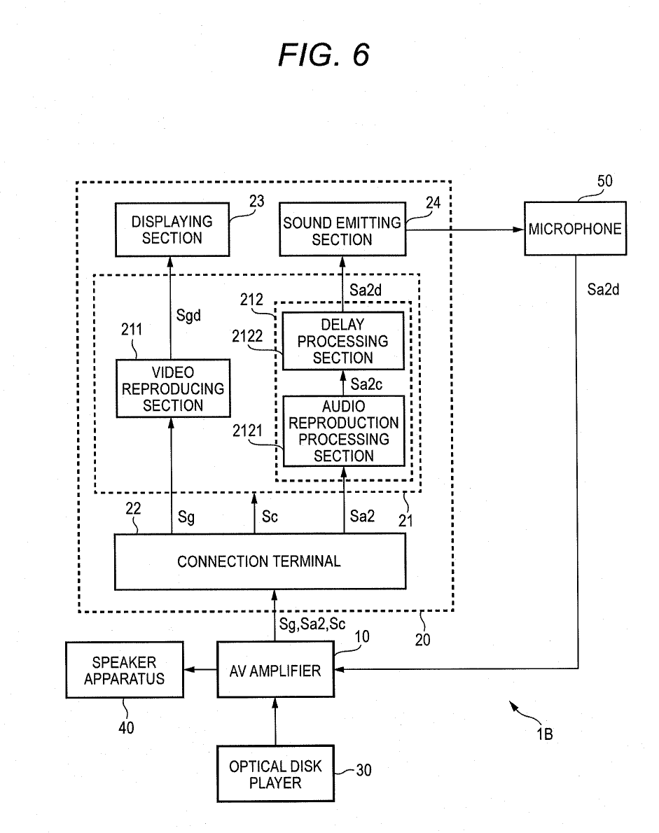

FIG. 6 is a block diagram illustrating the configuration of an AV system 1B in Modification 2 of the invention. A television receiver 20B in the AV system 1B shown FIG. 6 has a configuration which does not have the audio output terminal 25 in the embodiment. Similarly with the television receiver 20 in the embodiment, the television receiver 20B may have the audio output terminal 25. However, the reproduced audio signal Sa2d supplied from the audio reproducing section 212 is output to the sound emitting section 24.

The AV system 1B further has the microphone 50. A sound is input to the microphone 50, and the microphone converts the sound to an audio signal and then outputs the signal. In the example, the sound output from the sound emitting section 24 is input to the microphone 50, and the microphone outputs the converted audio signal as the reproduced audio signal Sa2d to the AV amplifier 10.

According to the configuration, the viewer may sometimes listen to the sound emitted from the sound emitting section 24. In order to prevent the sound from being heard by the viewer, therefore, it is preferable that the distance between the sound emitting section 24 and the microphone 50 is shortened, and the volume of the sound from the sound emitting section 24 is reduced. Alternatively, depending on the sound emission characteristics of the sound emitting section 24 and the sound pick-up characteristics of the microphone 50, an audio signal of a frequency band which is hardly heard by a human may be used as the delay measurement audio signal.

The microphone 50 may have a narrow directionality so as to attain a configuration where the sound emitted from the speaker apparatus 40 is hardly input. In the case where, for example, the sound emitted from the speaker apparatus 40 is input to the microphone 50 and the sound is in a specific frequency band, a filter which extracts the delay measurement audio signal may be disposed in the signal path from the microphone 50 to the delay measuring section 116 of the AV amplifier 10.

In another mode, in the case of a configuration where the television receiver 20 can output the reproduced audio signal Sa2d which is delayed in the audio reproducing section 212, through the connection terminal 22 or the like, the delay sound acquiring section 115 in the AV amplifier 10 may acquire the audio signal Sa2d which is supplied through the connection terminal 22. In this case, the delay measuring section 116 may compare the audio signal Sa2 supplied from the first outputting section 114 with the audio signal Sa2d acquired by the delay sound acquiring section 115.

(Modification 3)

In above-described embodiment, the AV amplifier 10 has been exemplarily described as the configuration having the DSP 11 functioning as the signal output apparatus. The application of the invention is not limited to the AV amplifier 10. The invention can be applied to various apparatuses as far as the apparatuses have a configuration where a video signal reproduced by an external apparatus is output and an audio signal is reproduced in an apparatus other than the external apparatus. For example, the signal output apparatus is incorporated in a game machine, a personal computer, an STB (Set Top Box), or the like, thereby causing the game machine or the like to have a function of the AV amplifier 10. In this case, the optical disk player 30 may not be connected. The AV amplifier 10 and the optical disk player 30 may not be integrally configured. Namely, even when the whole apparatus in which the signal output apparatus and a configuration where a video signal and an audio signal such as those contained in content data are produced are integrally configured is not connected to the optical disk player 30, a configuration where the video signal is supplied to the television receiver 20, and the audio signal is supplied to the speaker apparatus 40 may be formed.

Moreover, the AV amplifier 10 and the speaker apparatus 40 may be integrally configured.

Also the optical disk player 30 may be replaced with another apparatus such as a game machine, a personal computer, or an STB as far as the apparatus can output a video signal and an audio signal to the AV amplifier 10.

(Modification 4)

In above-described embodiment, the television receiver 20, optical disk player 30, and speaker apparatus 40 which are to be connected to the AV amplifier 10 are connected thereto through cables. However, the connections are not limited to wired connections, but may be realized by wireless connections.

(Modification 5)

In above-described embodiment, in the case where the difference between the measurement time period dt and the delay time period Td is equal to or larger than the change amount Tc, the delay control of the delay controlling section 117 updates the delay time period Td. The updation may be performed in another manner. For example, the delay controlling section 117 may control at any time so that the measurement time period dt and the delay time period Td coincide with each other (this corresponds to the change amount Tc=0). In the updation of the delay time period Td, the delay controlling section 117 may control so that the delay time period Td gradually approaches the measurement time period dt, and the contents of the delaying process are changed little by little.

(Modification 6)

In above-described embodiment, in accordance with the video signal Sg or genre information Sc supplied from the signal acquiring section 111, the measurement sound supplying section 112 produces the audio signal Sa2 for a predetermined time period, and the amount of temporal deviation is measured in the delay measuring section 116. In other words, the measurement in the delay measuring section 116 is performed by using a change of the format of the video signal Sg or the contents of the genre information Sc which are supplied from the signal acquiring section 111, as a trigger. There is a possibility that this change may cause the contents of the delaying process in the audio reproducing section 212 of the television receiver 20, to be changed. Therefore, the change is used as the trigger for starting the measurement in the delay measuring section 116. Consequently, another method may be used as the trigger for starting the measurement as far as it is possible to detect a change of the contents of the delaying process in the audio reproducing section 212.

In the case where, in the DSP 11 of the television receiver 20, the contents of the delaying process in the audio reproducing section 212 are changed such as the case where the reproduction mode is changed, for example, the output of the reproduced audio signal Sa2d may be sometimes muted. In such a case, from the input reproduced audio signal Sa2d, a change of the contents of the delaying process in the audio reproducing section 212 can be detected in the AV amplifier 10. Therefore, the measurement in the delay measuring section 116 may be started by using the detection (the detection of a muting operation) as a trigger.

The trigger is not limited to a muting operation. An operation sound which, in the audio reproducing section 212, is added to the reproduced audio signal Sa2d when an operation of the television receiver 20 is performed by the viewer through an operating section (not shown) may be detected in the AV amplifier 10, and the detection may be used as a trigger of the measurement start. In a configuration where the set contents of the DSP 21 are informed to the AV amplifier 10 through the connection terminal 22 or the like, the AV amplifier 10 may detect a change of the set contents, and the detection may be used as a trigger of the measurement start.

(Modification 7)

In above-described embodiment, in the case where the difference between the measurement time period dt and the delay time period Td is equal to or larger than the change amount Tc, the delay controlling section 117 updates the set contents of the delay time period Td. In the case where the format of the video signal Sg or the contents of the genre information Sc are changed during the delay control, even when the difference is not equal to or larger than the change amount Tc, the set contents may be updated. In this case, the delay controlling section 117 may monitor the video signal Sg or genre information Sc supplied from the signal acquiring section 111, and, when the format of the video signal Sg is changed, or when the contents of the genre information Sc are changed, and, in the determination in the first step SA130 (see FIG. 4) after the change, may deal with the value of the change amount Tc as a reduced value, for example, “0”.

(Modification 8)

The configuration of the DSP 11 in above-described embodiment may be realized by software or hardware, or by using an FPGA (Field-Programmable Gate Array). In the case where the configuration is realized by software, the AV amplifier 10 may have, in place of the DSP 11, a calculating section such as a CPU (Central Processing Unit), and a storage section such as a RAM (Random Access Memory) and a ROM (Read Only Memory). When a control program stored in the storage section is executed in the RAM, the configuration of the DSP 11 may be realized.

Such a control program may be provided in a state where the program is stored in a computer readable storage medium such as a magnetic storage medium (a magnetic tape, a magnetic disk, or the like), an optical storage medium (an optical disk or the like), a magnetooptical storage medium, or a semiconductor memory. Alternatively, the AV amplifier 10 may download the control program via a network.

According to an aspect of the invention, it is possible to provide a signal output apparatus which, even when information of the video reproduction processing time cannot be acquired from a display apparatus, measures the video reproduction processing time in the display apparatus, and which controls the delay time period of an audio signal.

What is claimed is:

1. A signal output apparatus comprising:
a signal acquiring unit configured to acquire a video signal and a first audio signal;
a measurement sound supplying unit configured to supply a second audio signal for measuring a delay;
a first outputting unit configured to output the acquired video signal and the supplied second audio signal to a reproduction apparatus that is configured to reproduce a video signal to be input and that is configured to delay and reproduce an audio signal to be input;
a delay acquiring unit configured to acquire the second audio signal which is delayed in the reproduction apparatus;
a measuring unit configured to compare the second audio signal which is output from the first outputting unit with the second audio signal which is acquired by the delay acquiring unit, to measure an amount of temporal deviation;
a delay controlling unit configured to apply a delaying process to the acquired first audio signal with a delay time period corresponding to the measured amount of temporal deviation; and
a second outputting unit configured to output the first audio signal to which the delaying process is applied, to a sound emitting unit.

2. The signal output apparatus according to claim 1, wherein:
the reproduction apparatus includes an output terminal through which the second audio signal is output; and
the delay acquiring unit acquires the second audio signal which is delayed in the reproduction apparatus from a signal output through the output terminal.

3. The signal output apparatus according to claim 1, wherein, when the measured amount of temporal deviation is changed to an amount which is equal to or larger than a predetermined change amount, the delay controlling unit changes the delay time period.

4. The signal output apparatus according to claim 1, wherein the measurement sound supplying unit produces an audio signal indicative of a measurement sound, and supplies the audio signal as the second audio signal.

5. The signal output apparatus according to claim 1, wherein the measurement sound supplying unit supplies the second audio signal by using the first audio signal which is acquired by the signal acquiring unit.

6. A signal output method comprising:
acquiring a video signal and a first audio signal;
supplying a second audio signal for measuring a delay;
outputting the acquired video signal and the supplied second audio signal to a reproduction apparatus that is configured to reproduce a video signal to be input and that is configured to delay and reproduce an audio signal to be input;
acquiring the second audio signal which is delayed in the reproduction apparatus;
comparing the output second audio signal with the acquired second audio signal, to measure an amount of temporal deviation;
applying a delaying process to the acquired first audio signal with a delay time period corresponding to the measured amount of temporal deviation; and
outputting the first audio signal to which the delaying process is applied, to a sound emitting unit.
